(19) United States
(12) Patent Application Publication
(10) Pub. No.: US 2018/0261069 A1
(43) Pub. Date: Sep. 13, 2018

(54) SAFETY DETECTION IN SEALED VEHICLE SPACES

(71) Applicant: David HONEY-JONES, Yellow Grass (CA)

(72) Inventor: David HONEY-JONES, Yellow Grass (CA)

(21) Appl. No.: 15/761,009

(22) PCT Filed: Sep. 19, 2016
(86) PCT No.: PCT/CA2016/000236

§ 371 Date: Mar. 16, 2018

(30) Foreign Application Priority Data
Sep. 17, 2015 (CA) 2,904,745

(51) Int. Cl. G08B 21/14; G08B 21/24; G08B 21/22; B60Q 1/52; B60Q 5/00

(52) U.S. Cl. CPC G08B 21/14; G08B 21/24; B60Q 5/005; B60Q 1/52; G08B 21/22

(57) ABSTRACT

A safety alert system for use in a motor vehicle cabin. A temperature sensor and a carbon dioxide sensor operate in conjunction to detect the presence of a person within the sealed vehicle cabin in unsafe circumstances. Based upon preset parameters, a local alarm or notification or operator notification can be triggered in the vicinity of the vehicle if an alert condition exists, or in some embodiments remote alert notifications can be triggered to vehicle owners or safety authorities. An auxiliary carbon dioxide sensor could be located within the trunk of the vehicle in addition to within the vehicle cabin. A video capture subsystem could also be included, to capture video of the cabin of the vehicle on detection of the alert condition, and the video could be archived or transmitted to safety personnel. The method of detection of a human in an unsafe vehicle environment is also disclosed.

This invention is in the field of automobile safety. More specifically it deals with a detection system and method for use in the detection of the stranding or unsafe location of a human in a vehicle in an unsafe temperature or carbon dioxide level environment.

### BACKGROUND

One of the key safety threats for people travelling in or living in proximity to motor vehicles is the stranding of children or other adults for a long period of time in a sealed vehicle cabin with no oxygen or air refreshment. Particularly in a situation where the temperature within the vehicle cabin is high or rising, the lack of fresh air and the increasing levels of carbon dioxide present within a vehicle cabin can cause discomfort or in a worst case scenario fatality for an individual stranded within a vehicle cabin. Situations where this occurs or is a possibility include circumstances in which parents might for example leave their children in a vehicle while they are running errands, children trapping themselves in a stationary vehicle while playing or the like.

If it were possible to detect the presence of an individual stranded in such a situation and provide some type of an alert or alarm this would be desirable. One detection parameter which can be used is to monitor the relative carbon dioxide levels within the vehicle cabin, as humans exhaust carbon dioxide from breathing, and in the lack of refreshment of the air within the confined space, a breathing human will cause eventual detectable increase in carbon dioxide levels.

Problems in the prior art attempts at addressing this safety situation include the cost and complexity of installing a monitoring system to detect the existence of such threat conditions. For example, the incorporation of an OEM installed carbon dioxide threat detection system is complex and costly. If it were possible to provide a carbon dioxide detection method and apparatus for use in either OEM or retrofit applications that was of reasonable cost and simple to install it is felt that the adoption rate of such safety monitoring technology would be maximized, and lives could be saved.

In addition to addressing the issue of complexity and cost for the use this type of an apparatus to save lives, another technical limitation to be addressed is that of the power demand on the battery system of the vehicle. The primary time for operation and use of such a system is when the vehicle is not running and as such it would require a power draw on the battery of the vehicle. In order to minimize the power draw of the unit or adverse effect on the power system of the vehicle, a detection device with minimal power draw or enhanced power management features would be desirable.

### SUMMARY OF THE INVENTION

As outlined above, it is the object of the present invention to provide a safety alert system and method to allow for the detection of the presence of one or more living beings within a confined space such as a vehicle cabin, and provide local or remote alarm notifications of the potential stranding of those individuals in that circumstance.

As further outlined above, it is the object of the present invention to provide a safety alert system and method to allow for the detection of the presence of one or more living beings within a confined space such as a vehicle cabin which uses equipment which is reasonably simple to install in a vehicle and can be used cost-effectively in both OEM or retrofit applications.

As further outlined above, it is the object of the present invention to provide a safety alert system and method to allow for the detection of the presence of one or more living beings within a confined space such as a vehicle cabin, the detection method of which is based upon the detection of increasing carbon dioxide levels within the confined space.

The invention, a safety alert system for use in a motor vehicle having a vehicle cabin, accomplishes its objectives comprising a controller for mounting on board the vehicle, which controller has a processor was safety detection software executable thereon. The controller could comprise any number of different types of electronic processors, programmable logic controllers or the like, as will be understood to those skilled in the art. The controller will have a carbon dioxide sensor for location within the vehicle cabin, operatively connected thereto, to provide carbon dioxide readings from within the vehicle cabin to the processor, along with the temperature sensor for location within the vehicle cabin to operatively connected to the controller provide temperature readings from within the vehicle cabin to the processor. A local alarm or notification device is also operatively connected to the controller and attached on board the vehicle to provide audible notification outside the vehicle when actuated.

The alarm condition which the system of the present invention will detect is the unsafe presence of at least one living being within the vehicle cabin, which is typically contemplated to comprise the unattended presence in a dangerous situation of at least one living being in the vehicle cabin in an elevated carbon dioxide environment i.e. where the living being was unattended in the vehicle and unsafe levels of carbon dioxide were accumulating therein. The carbon dioxide sensor and the temperature sensor, which readings are provided to the controller, can based upon the readings in conjunction provide sufficient information either in real time or and compared sample readings to determine the presence of humans or other living beings within the vehicle, where increasing carbon dioxide levels could be an indicator of a heightened threat situation within that area.

A auxiliary carbon dioxide sensor could be used in additional isolated areas of the vehicle, either with or without another pair temperature sensor, to allow the same controller and system to monitor more than one area within the vehicle for alert purposes.

If it was determined that the alarm condition existed within the vehicle i.e. if it was determined that the parameters for the detection of the alarm condition were met, for example by determining the carbon dioxide levels were increasing along with the temperature within the vehicle cabin to indicate the presence of at least one living being in the vehicle in an unsafe situation, a local alarm or notification being an audible or visible alarm could be triggered and hopefully individuals in proximity to the vehicle would come to the aid of those living beings trapped therein. An audible alarm could consist of a siren, or a speaker making some type of a stored in prerecorded local-area announcement in the vicinity of the vehicle in question, and or visible alarm could consist of blinking the likes of the vehicle, flashing and added light or other visual indicator. Both audible and visible alarms could be used although it is primarily contemplated that an audible alarm would be required to provide maximum local-area notification for the safety of the living beings who might be trapped within the vehicle.

In some embodiments of the system and method of the present invention the system might also include a network interface and or a geolocation interface operatively connected to the remainder of the controller and the system, by which remote alert notifications could be transmitted to safety authorities, owners or otherwise if an alert condition was detected. Where geolocation interface was included, the location of the vehicle could be captured and transmitted along with the remainder of a remote alert notification, where a remote alert notification was being transmitted for the purpose of alerting authorities or the owner etc. to the existence of an alarm condition within the vehicle.

Certain embodiments of the system can also include additional sensors or detection routes within the vehicle cabin which could be used to provide a higher level of certainty or alternative detection mechanisms for determination of the unsafe presence of living beings within the cabin of the vehicle in question. For example, video capture device such as a video camera might be integrated into the system of the present invention and by its operative connection to the controller video capture and video based detection abilities could be added to the system. For example with the integration of at least one video capture device into the system, if an alarm condition were detected such that a local or remote notification were to be provided of the existence of an unsafe condition within the vehicle, video from the video capture device could be captured and stored. Where the system included a network interface operatively connected to at least one remote notification device or remote notification system, video captured from the video capture device upon detection of the alarm condition could be transmitted to the remote notification device along with the remainder of the remote notification. Even in circumstances where the video capture device was not used to capture and transmit video from within the cabin of the vehicle, the controller could process video captured from the video capture device to ascertain the presence of one or more living beings within the cabin of the vehicle and the video capture approach could be used to validate with a higher degree of certainty for example the forecast or detection of living beings within the vehicle cabin based upon the carbon dioxide and temperature readings.

Other types of sensors should also be used to provide a higher degree of certainty in the detection or validation of the detection of living beings within the cabin of the vehicle. For example an audio capture device could be operatively connected to the controller, such that audio captured within the cabin of the vehicle could also be used to assist in the detection of the presence of living beings within the vehicle cabin. A seismic sensor could also be used to enhance the degree of accuracy of the remainder of the device by providing seismic sensor readings to the controller and the software thereon for use in the detection of the existence of an alarm condition within the cabin of the vehicle.

Some embodiments of the system of the present invention could also be connected to the vehicle data bus, which would allow for the use of vehicle environmental or control data which could be read from that bus by the controller and the remainder of the method of the present invention. Many motor vehicles of newer manufacturer provide a simple ODB port connection by which devices such as the controller of the present invention can be connected in a read-only way to the data bus of the vehicle and it is explicitly contemplated that certain embodiments of the system and method of the present invention could exploit this type of a integration or interface to again provide a higher level of functionality or certainty in the operation of the detection method of the present invention. Connection to the vehicle data bus would not only allow for the simplified use of vehicle ignition information in the operation of the method of the present invention, but the values are readings which could be obtained from certain sensors within or upon the vehicle could also be used—for example some vehicles may have a cabin temperature sensor installed therein which could be used in the place of the need for a separate sensor operatively connected or manufactured integrally along with the remainder of the controller of the present invention.

It is primarily contemplated that the system of the present invention would operate when the ignition of the vehicle in which it is installed is turned off. In addition to simply monitoring the ignition status of the vehicle, some embodiments of the system and method of the present invention might include additional parameters by which the operability of the system could be determined—for example in order to preserve power of the vehicle, it might be determined that it would only operate the system of the present invention within a particular temperature range. If the temperature range was lower than a particular preset number, it could be assumed that at least from the purpose of monitoring carbon dioxide levels, the individual or individuals would all be out of the vehicle. Many different types of monitoring condition parameters or even alarm condition parameters can all be contemplated and will all be understood to those skilled in the art of safety system design electronic hardware design for use in motor vehicles as outlined herein and all such ideas are contemplated within the scope of the present invention.

The safety alert system hardware of the present invention could be further enhanced by incorporating elements of redundancy into the system to allow for an additional level of comfort and security to the user—for example by the incorporation of redundant sensors, controllers or power supplies as might be required or desirable in the manufacture of particular embodiments of the hardware in question.

In addition to the system of the present invention there is also disclosed the method of detection of an alarm condition in the environment of the vehicle cabin of the motor vehicle, the alarm condition being the unsafe presence of at least one human being in an elevated carbon dioxide environment in the vehicle cabin. The method would comprise providing within the vehicle a safety alert system in accordance with the present invention which overall comprises a controller for mounting on board the vehicle which has a process or the safety detection software executing thereon, a carbon dioxide sensor for location within the vehicle cabin and operatively connected to the controller to provide carbon dioxide readings from within the vehicle And the processor, temperature sensor for location within the vehicle cabin and operatively connected to the controller to provide temperature readings from within the vehicle cabin to the processor, and a local alarm or notification device operatively connected to the controller attached onboard the vehicle to provide notification outside the vehicle when actuated.

Using the safety alert system, the method further comprises the steps of first periodical capturing temperature and carbon dioxide readings within the cabin the vehicle, from the temperature sensor and the carbon dioxide sensor to the controller, and then using the controller and the safety detection software to determine the existence of an alarm condition based on the captured temperature and carbon dioxide readings. If no alarm condition exists and monitoring conditions do continue to exist, monitoring can continue.

Where it is determined by the controller and the resident software that an alarm condition exists within the cabin of the vehicle, the controller can actuate the local alarm or notification device to provide local notification alarm in the vicinity of the vehicle.

In certain embodiments of the method of the present invention, the controller of the safety alarm system could be operatively connected to the vehicle data bus such that the controller could use on board control or data readings from the vehicle in determining the existence of the alarm condition. Onboard vehicle sensors could be used in place of separate carbon dioxide and temperature sensors, if they existed and were readable via the vehicle data bus.

For example if the vehicle had an integrated interior temperature sensor within the vehicle cabin, that could be used either as the primary temperature sensor or could also be used as a failover or redundant temperature sensor if required to obtain a temperature sensor related to the interior temperature of the vehicle. Similarly other available data readings on the vehicle, which could be read from the vehicle data bus, could also be used by the remainder of the system and the controller of the present invention in the safety alert detection method of the present invention.

It is specifically contemplated that in order to minimize the power consumption of the system of the present invention on the vehicle that it would only operate to monitor the interior of the vehicle cabin of relevant times—for example it may be assumed that it is not necessary to monitor the interior of the vehicle while the ignition is engaged, the vehicle is moving or the like. Many of these data points can be captured again either from the vehicle data passive the system is operatively connected thereto, or the controller could operatively be connected until to the other relevant control systems on the vehicle to allow for such detection. It is specifically contemplated that when the vehicle is turned off, the presence of living beings within the vehicle cabin can be determined by sensing increasing temperature and increasing carbon dioxide levels in the cabin. If the vehicle is in operation it can reasonably be assumed that the method of the present invention is not required, so the actuation of the vehicle or other conditions could also be included within the detection parameters used by the controller to determine the existence of the alarm condition.

It is specifically contemplated as in the case of the system and controller of the present invention that the method could also be practised using a system which had a network interface on the controller connected to a network by which the controller could communicate the at least one remote notification device, whereby the detection of the existence and alarm condition and the vehicle cabin a remote alert notification will be transmitted to the at least one remote notification device. The remote notification device might be the remote or portable device of the vehicle owner or operator, or might be a data centre or other device of safety personnel or law enforcement authorities as well. The network interface could be a wide area IP network interface, a cellular modem, or any number of other types of remote communication technologies which will be understood to those skilled in the art of design of such systems and all such approaches are contemplated within the scope of the present invention.

Where the system of the present invention included a video capture device located within the cabin and operatively connected to the controller, the controller could trigger the capture and storage of video within the cabin of the vehicle where alarm condition was detected, or it could also be the case that the safety detection software on the controller could process video captured by the video capture device to identify the presence of living beings within the vehicle cabin to enhance the level of accuracy of the temperature and carbon dioxide based detection method otherwise outlined herein. In certain cases as well, the presence of the video capture device could be used in the place of the temperature carbon dioxide sensors, as the captured data stream which would be used to determine the presence of at least one living beings within the cabin of the vehicle. In embodiments of the system of the present invention including a remote network interface and a video capture device, upon detection of alarm condition captured video could be transmitted to the remote notification device again whether that be the device of the operator or owner of the vehicle or to safety personnel etc. Similar to the use of video signals captured within the cabin to validate or determine the presence of living beings therein, there could also be the use of an audio capture device within the cabin of the vehicle provided as an alternative datastream or enhancement to enhance the level of validation or certainty in the detection method outlined otherwise herein. Other types of sensors could also be used, including seismic sensors or the like, to further enhance the accuracy of the method.

### BRIEF DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numerals, and where:

FIG. 1 is a block diagram of one embodiment of the safety alert system of the present invention;

FIG. 2 is a flow chart demonstrating the steps in one embodiment of the safety monitoring method of the present invention, using the hardware of FIG. 1;

FIG. 3 is a block diagram of a second embodiment of the safety alert system of the present invention, incorporating an auxiliary carbon dioxide sensor as well as a remote network interface on the controller;

FIG. 4 is a flow chart demonstrating the steps in an alternate embodiment of the safety monitoring method of the present invention, using the hardware of FIG. 3;

FIG. 5 is a block diagram of a third embodiment of the safety alert system of the present invention, incorporating video capture and additional sensors operatively connected to the controller, and a connection to the vehicle data bus;

FIG. 6 is a flow chart demonstrating the steps in an alternate embodiment of the safety monitoring method of the present invention, using the hardware of FIG. 5;

FIG. 7 is a schematic diagram demonstrating the use of a network enabled safety alert system in accordance with the remainder of the present invention installed in a motor vehicle, including an external network interface.

### DETAILED DESCRIPTION OF THE INVENTION

As outlined above, the general focus of the present invention is to provide a streamlined and cost-effective method to monitor the interior of a vehicle cabin such as the cab or the trunk of a motor vehicle, to ascertain if there is one or more living beings within that vehicle space in an increasingly toxic carbon dioxide environment, and upon detection of the existence of such alarm condition to provide either a local alarm or notification or a remote notification of the existence of these conditions to ensure the safety of these living beings. In the context of the invention, “living beings” is primarily intended to encompass human beings, although pets or other animals could also be detected for safety purposes and that is also contemplated within the scope of the present invention.

### Method Overview:

The system and method of the present invention will monitor the temperature within a vehicle cabin, and the carbon dioxide concentration in the air therein. The system of the present invention will be active whenever the ignition of the vehicle was turned off, such that if the ignition of the vehicle is off and it is determined that the temperature and the carbon dioxide concentration within the vehicle cabin is increasing, that is an indicator of the presence of a life form within the vehicle which may require attendance or alert. The specific parameters of the rise in temperature or carbon dioxide concentration which would occasion the detection or characterization of an alarm condition could be adjusted based upon numerous environmental parameters. The device itself could be programmed to allow the user to adjust these parameters for a level of sensitivity although it is likely that this would explicitly be avoided and a hardcoded alarm condition algorithm incorporated therein.

The safety monitoring method would be engaged within the cabin or other confined spaces for monitoring in a motor vehicle, when the vehicle ignition was turned off. It is assumed for the purposes of monitoring that if the vehicle is running, there is sufficient air circulation or there is an attentive operator in the vehicle to mitigate the need for monitoring during the times when the vehicle ignition was turned on. In certain embodiments if it was for some reason desired to operate the method and hardware of the present invention during ignition time frames for the vehicle that could also be easily adjusted into the programming of the electronic circuitry of the invention as well as the overall method.

Generally speaking the steps in the method of the present invention are as follows. When the ignition of the vehicle is turned off, a controller with the temperature sensor and the carbon dioxide sensor within the vehicle cabin such as the cabin will be activated. The controller will either in an immediate real time method, or based upon a programmed timeframe for snapshots or sampling of the environment within the vehicle, monitor the vehicle cabin to detect an increase in temperature and carbon dioxide concentration in the air within that vehicle cabin, which would signify the presence of one or more living beings within the vehicle cabin. An individual within the vehicle who was breathing would create more carbon dioxide in the environment within the vehicle, every time they breathed, subject to there being sufficient ventilation in the vehicle or the vehicle being in operation. If the carbon dioxide in temperature levels within the cabin or other confined space of the vehicle were increasing, this would signify the presence of a living being within the confined space which, when that threshold was met, would constitute the alarm condition which the system was intended to detect and notify.

If the controller detects an alarm condition based upon the sampling of temperature and carbon dioxide levels within the vehicle cabin, which would effectively be the determination that there was one or more living beings in the vehicle based upon increasing temperature and carbon dioxide levels, a local alarm or notification could be triggered. The local alarm or notification is explicitly contemplated to be an audible sound outside of the vehicle with a speaker seeking to capture the attention of one or more individuals nearby who could examine the vehicle and ascertain the safety of anyone therein. A visible alarm of a local nature could also be used—a flashing light or the like. Upon triggering of a local alarm or notification based upon the determination of the existence of an alarm condition, the local alarm or notification could continue to sound either until it was deactivated or until the alarm condition ceased to exist.

In certain embodiments of the present invention, the controller might have one or more additional carbon dioxide sensors attached thereto which were located in additional confined spaces on the vehicle—for example it is specifically contemplated that an additional carbon dioxide sensor might be mounted within the trunk of the vehicle such that for example children playing in the vehicle or for some other reason someone got locked in the trunk of the vehicle, the increasing carbon dioxide levels therein again could trigger the local alarm or notification, or in some cases additional remote notification if the particular system or hardware question at remote notification capabilities.

The local alarm or notification is contemplated to most likely consist of a customizable audio file for playback on a speaker outside of the vehicle. It will be understood that the audio file itself could be varied based upon the programming installed by the vendor of the hardware, or even in certain cases additional audio files could be used and selected by the programming and controller hardware based upon the level of severity of the readings and the like. Any type of an audible or visible alarm is contemplated within the scope of the present invention.

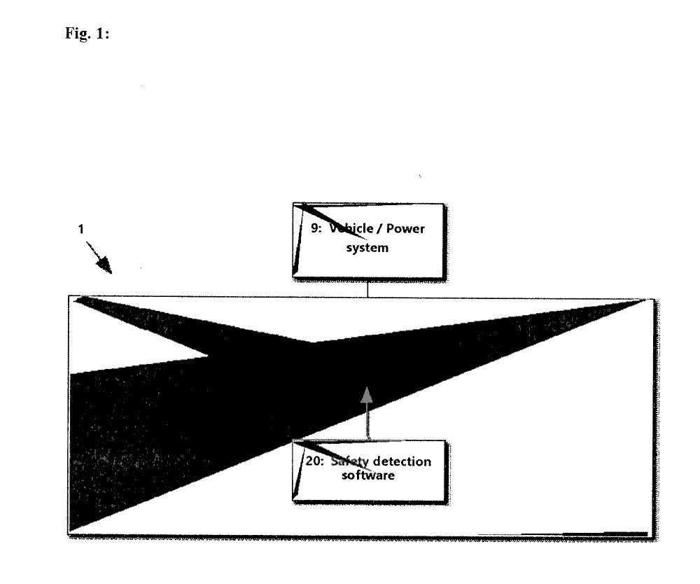

Referring first to FIG. 1 there is shown one embodiment of a safety alert system 1 in accordance with the present invention. The safety alert system 1 shown in this Figure is connected to the power system 6 of the vehicle. In other embodiments as will be outlined in further detail below the power system 6 might in some way be integrated into the system 1 itself and both such approaches are contemplated within the scope of the present invention.

The primary component of the system 1 is a controller 2. The controller 2 will be an electronic controller, with related safety detection software, that is capable of facilitating the method of the present invention in accordance with or in conjunction with the remaining components outlined below and the method outlined herein. The controller 2 would be capable of communication with a plurality of inputs from sensors, as well as triggering at least one output to a local alarm 5 based upon the detection of the existence of an alarm condition. Many different types of microprocessors, programmable logic controllers or other hardware will be understood to those skilled in the art of electronic circuit design as being capable of functioning as the central controller 2 in accordance with the remainder of the present invention at all such hardware, or hardware and software combinations, are contemplated within the scope of the present invention.

Also shown in this Figure is the safety detection software 20 executable on the controller 2. The safety detection software 20 will comprise any necessary processor instructions for execution by the controller 2 to execute the method of the present invention and it will be understood that many approaches or modifications could be taken to the development or coding of the necessary safety detection supper 20 to implement the method as desired, and all such approaches, meaning all such hardware and software combinations of the controller 2 and the safety detection supper 20, are again contemplated within the scope of the present invention.

Shown connected to the controller 2 is firstly a temperature sensor 3. The temperature sensor 3 will monitor the temperature within the vehicle cabin, such as the vehicle cabin or the like, within which the system 1 is installed. The temperature sensor 3 might be integral within the system 1 itself, or might be wired to the remainder of the controller 2 in the case where the temperature sensor 3 was to be located in a separate location within the vehicle cabin from the remainder of the system 1. Both such approaches are contemplated within the scope hereof.

The temperature sensor 3 will be capable of either on an ongoing basis or on a periodic sampling basis capturing the temperature reading within the vehicle cabin, and communicating the temperature reading within the vehicle cabin to the controller 2 via a input bus, for use in the execution of the remainder of the method of the present invention.

Also shown in addition to the temperature sensor 3 is a second sensory input to the controller 2, namely a carbon dioxide sensor 4. The carbon dioxide sensor 4 would sample carbon dioxide readings within the vehicle cabin again on a real-time or periodic sampling basis, and communicate those sensor readings from the carbon dioxide sensor 4 to the controller 2 via an input bus. The software and hardware of the controller 2 would receive and process readings from the temperature sensor 3 and the carbon dioxide sensor 4 for use in the conduct of the remainder of the method of the present invention.

Also shown connected to the controller 2 is a local alarm or notification 5. The local alarm or notification 5 will comprise a speaker or any other type of an audible or visible alert system that is capable of generating an alert within proximity of the vehicle itself, to cause individuals within proximity of the vehicle to check on the safety of living beings therein. The local alarm or notification 5, similar to the temperature sensor 3 and the carbon dioxide sensor 4, could be integral within the system control unit 1, or could be a separately attached speaker 5 located on the vehicle or somewhere else outside the vehicle such that it could cause sufficient indication or alert on its activation to cause proximity awareness of a potential problem.

In the embodiment of FIG. 1, the local alarm or notification 5 is specifically contemplated to be a speaker, and the local alarm or notification activity which is specifically contemplated at the time that an alarm condition is detected is an alarm within the proximity of the vehicle. The local alarm or notification 5 being a speaker located outside of the vehicle would sound, causing local awareness for individuals in proximity of the vehicle to look and make sure that there is no safety issue for individuals therein. As is outlined elsewhere herein, the local alarm or notification 5 might also comprise visible alarm components.

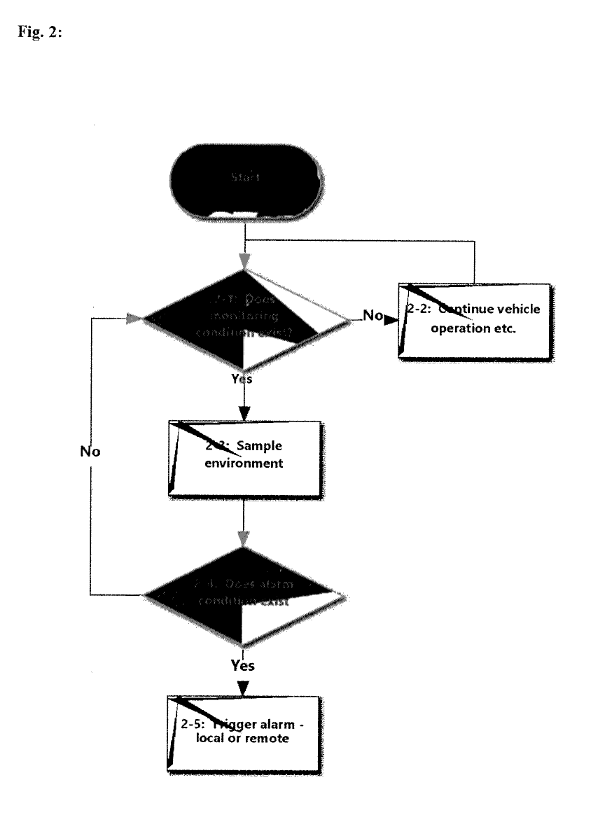

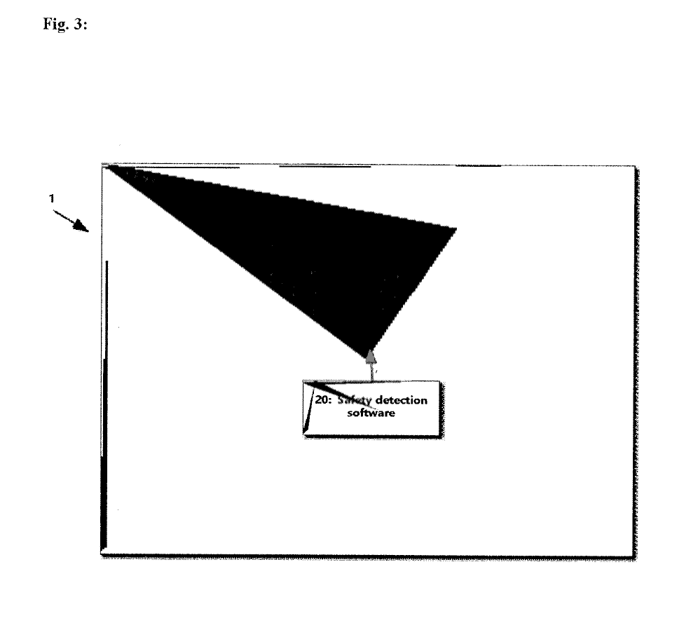

FIGS. 2 and 3 show an alternate embodiment of the system and method of the present invention. Referring first to the system itself as shown in FIG. 3, there is shown a safety alert system 1 in accordance with the present invention. The system 1 shown in this Figure includes an onboard power system 9, versus being connected to the power system of the vehicle. Either approach will be understood to be within the scope of the present invention. Various types of power systems can be contemplated, for the purpose of providing power and control to the remainder of the system 1 of the present invention.

Similar to the system 1 shown in FIG. 1, there is shown a controller 2 with an input bus with a temperature sensor 3 and the carbon dioxide sensor 4 attached thereto. The controller 2 also is shown along with safety detection software 20 which are the necessary processor instructions for the control 2 to administer and execute the method of the present invention also shown, similar to the embodiment of FIG. 1, is a local alarm 6 again operatively connected to the controller to such that it can be actuated to provide a local alert or alarm notification when the alarm condition is determined to exist in accordance with the remainder of the method.

The system embodiment of FIG. 3 also shows an auxiliary carbon dioxide sensor 5, which could be mounted in an additional isolated compartment of the vehicle in addition to the cabin in which the primary carbon dioxide sensor 4 was mounted. It is basically contemplated that additional auxiliary carbon dioxide sensors 5 could operably be connected to the controller 2 to provide extended applicability and operability of the monitoring method of the present invention in additional isolated spaces in the vehicle. Additional sealed areas of the vehicle might also require an additional temperature sensor 3, although in the case of the trunk of the vehicle, since really no humans should ever be in the trunk of the vehicle for any kind of an extended period of time monitoring only the carbon dioxide levels in the cavity should be sufficient as there should never be anyone in there for long enough that the monitoring of an increased temperature level should be required. The carbon dioxide sensor 5 will be connected to the controller 2 and will be integrated into the remainder of the programming of the software and the controller 2, for the purpose of monitoring the carbon dioxide levels in an additional area of the vehicle.

Also shown as a network interface 7, by which the controller 2 could communicate with external and remote notification devices. It is basically contemplated that where a network interface 7 was included with the controller 2, the controller 2 could communicate with remote notification devices being a remote or portable device of the operator or owner of the vehicle, or even law enforcement or safety and emergency personnel, such that when the alarm condition was detected remote condition notifications could be dispatched in addition to a local notification or alarm be provided within the vicinity of the vehicle. As outlined elsewhere herein, the network interface 7 could be an IP interface to a local area network or wide-area network or a cellular modem or the like to allow for transmission of communications further afield. The network interface can also be an SMS interface or an interface allowing for communication by one or more protocols on one or more communications networks for the purpose of transmitting a notification of the existence of an alarm condition of the system 1.

Also shown in the embodiment of FIG. 3 is a geolocation module 8. Certain controllers 2 might include the geolocation module 8 on the board of the controller 2, or the geolocation module 8 might be a freestanding module separately attached to the controller 2. The geolocation module 8 is contemplated to be a GPS module which would allow for determination and capture of the location of the vehicle, so that the vehicle location could be included in remote alarm notifications dispatched upon the termination of the existence of alarm conditions in the vehicle.

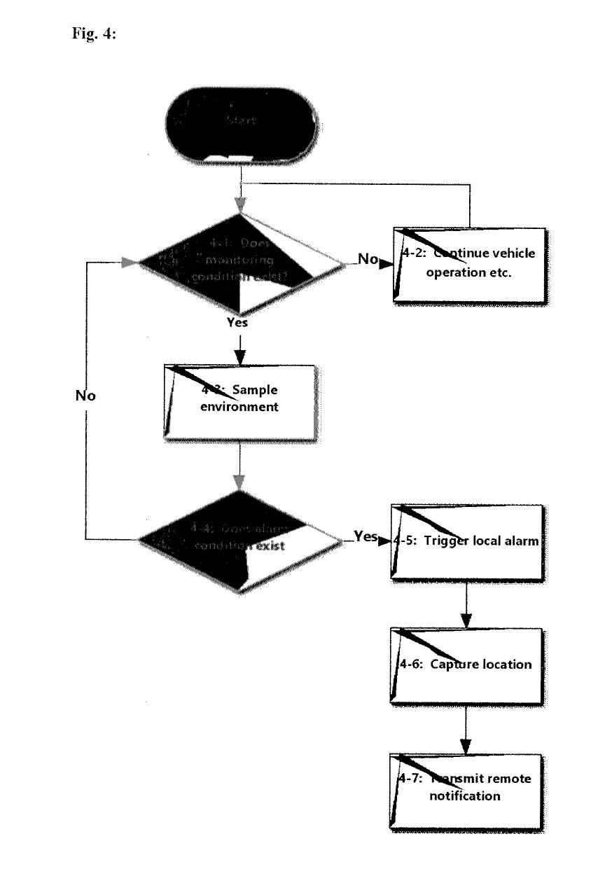

Referring to FIG. 4 there is shown of flowchart demonstrating an alternate embodiment of the safety alert method of the present invention. The method of FIG. 4 would be executed using a system 1 similar in configuration to that shown in the block diagram of FIG. 3.

The first step in the method of FIG. 4, shown at step 4-1, is the Boolean determination of whether or not monitoring conditions exist. Basically this determines whether or not the monitoring method of the present invention is activated i.e. in circumstances where it is desired to only conduct a monitoring method of the present invention when the mission of the vehicle was turned off or the like, the controller 2 via its various sensors could determine whether or not the method and the controller 2 with its related hardware should be activated. If it is determined that monitoring conditions do not exist i.e. the vehicle is operating and otherwise the method of determination of the existence of a safety alarm condition and the vehicle is not required, vehicle operation etc. could be continued, as shown at 4-2. It is primarily considered that the existence of a monitoring condition would equate to whether or not the vehicle ignition is turned on, but there could be other monitoring conditions which could be programmed or activated, based upon the programming on the controller 2 or one or more control inputs connected to the controller 2 from the remainder of the vehicle.

It is primarily contemplated that a monitoring condition exists if the ignition of the vehicle in which the remainder of the system 1 is installed is turned off, versus of the vehicle is operating there is an attentive and capable driver in the vehicle operating controls of the vehicle such that the carbon dioxide threat should not be problematic. There could however be additional layers of logic applied to the detection of the existence of a monitoring condition.

Given the presence of at least one temperature sensor 3 within the vehicle, for example, a monitoring condition might be said to only exist, such that the remainder of the method would be practised, within a particular temperature range. This would allow for the shutdown of the remainder of the method of the system outside of operating parameters, to preserve power within the vehicle, since if the majority of operating or monitoring conditions in respect of the system 1 take place for the ignition is turned off, power conservation on the vehicle power bus will be essential, so as to not only drain the power and the battery system on the vehicle.

It will be understood to those skilled in the art of system design that the detection loop here for the detection of a monitoring condition could be configured in different ways as well. For example rather than testing the operating parameters within the environment of the vehicle to determine the existence of a monitoring addition, the monitoring condition logic could be simplified, and power consumption of the device further optimized, by simply enabling the system 1 and the remainder of the method of the present invention purposefully when the vehicle ignition is turned off. If the vehicle ignition is turned on, the system 1 is turned off, and vice versa. Many different types of approach to this can be contemplated and all are contemplated herein.

If it is determined that the method of the present invention should be activated, the controller 2 would conduct, either on a periodic sampling or real-time basis, the environmental sampling required within the environment of the vehicle cabin to ascertain whether or not the danger condition of at least one living being in an elevated carbon dioxide environment exists within the vehicle. This is shown at 4-3. The sampling taking place at this step in the process would consist of temperature and carbon dioxide sampling taking place using the temperature sensor 3 of the carbon dioxide sensor 4 within the vehicle cabin. The controller 2 would assess, based upon the readings captured from the temperature sensor 3 and the carbon dioxide sensor 4 the presence of living beings within the vehicle cabin based upon increasing temperature or increasing carbon dioxide levels within the vehicle cabin. The specific parameters to be used in the comparison or assessment of those readings would be programmed within the safety monitoring software 20 executed on the controller 2.

If based upon the sample readings obtained at step 4-3, the controller 2 determines that there is no alarm condition i.e. there are no living beings left in the vehicle cabin in a monitoring situation, the monitoring loop shown in the Figure would continue. The logic block related to the determination of the existence of the alarm condition is shown at 4-4. If for example based either on the current readings from the temperature sensor 3 and the carbon dioxide sensor 4, or based on data and readings between samples from those sensors, it is determined that there is a risk to individuals within the vehicle and the vehicle is determined to even have individuals contained therein, based on increasing temperature and carbon dioxide readings, the local alarm or notification could be triggered.

If it was determined in a monitoring situation that the alarm condition which is monitored by the system of the present invention existed i.e. that living beings were left in the vehicle cabin in an unsafe environment, which is determined by measurement of an increasing carbon dioxide level in the environment of the vehicle, the local alarm would be triggered by the controller 2 activating the local alarm 6 connected thereto, shown at step 4-5. Additionally, using the system 1 shown in FIG. 3, the geolocation module 8 would capture the location of the vehicle, shown at step 4-6, and at least one remote alarm notification will be transmitted by the controller 2 via the network interface 7 to at least one remote notification device—the vehicle location, captured by the geolocation module 8—could be included in that remote notification, so that the person receiving the remote notification could easily and quickly locate the vehicle. The unsafe environment in which the living beings were left might comprise an elevated carbon dioxide environment within the vehicle cabin i.e. it may be the case that the system is used to actually detect the presence of living beings in a vehicle cabin with sufficient carbon dioxide presence to be dangerous, or it may also be the case that the presence of elevated carbon dioxide levels are simply used to otherwise detect an unsafe environment be for example a person or companion animal etc. being abandoned within the cabin of the vehicle for an extended period of time even where the carbon dioxide level in the vehicle itself may not pose a threat or risk, but the carbon dioxide level is simply used as an indicator of the presence of living beings in the vehicle. For example, the presence of children or pets in the vehicle could be detected based upon elevating carbon dioxide and temperature levels in the vehicle, and the abandonment of those children or pets in the vehicle regardless of the threat risk posed by the carbon dioxide in the cabin itself might comprise the unsafe environment which was desired to detect and alert.

The safety monitoring software 20 could obviously use other internal parameters as well in the determination of the existence of an alarm condition—for example monitoring a period of time associated with the presence of the living beings in the vehicle cabin in addition to the rising carbon dioxide or temperature levels might be an added parameter which is used in certain embodiments to determine the existence of the alarm condition i.e. even though the system might be able to reasonably quickly determine the presence of living beings within the vehicle cabin it may be for example desired to allow for 15 minutes delay from the turning off the ignition of the vehicle, before an alarm was to be sounded on the presence of living beings in the vehicle cabin. This is entirely optional but it will be understood to those skilled in the art of safety monitoring and software design such as that outlined herein that any number of types of either sensor-based parameters or internally programmed parameters could be used by the safety monitoring software 20 in the determination of the existence of alarm condition and any such approaches are all contemplated within the scope of the present invention. Based upon the local alarm or notification and the remote notifications transmitted it is hoped that the individual or individuals within the cabin of the vehicle who were potentially stranded therein at elevated temperature or carbon dioxide levels would be saved in advance of encountering health difficulty therefrom.

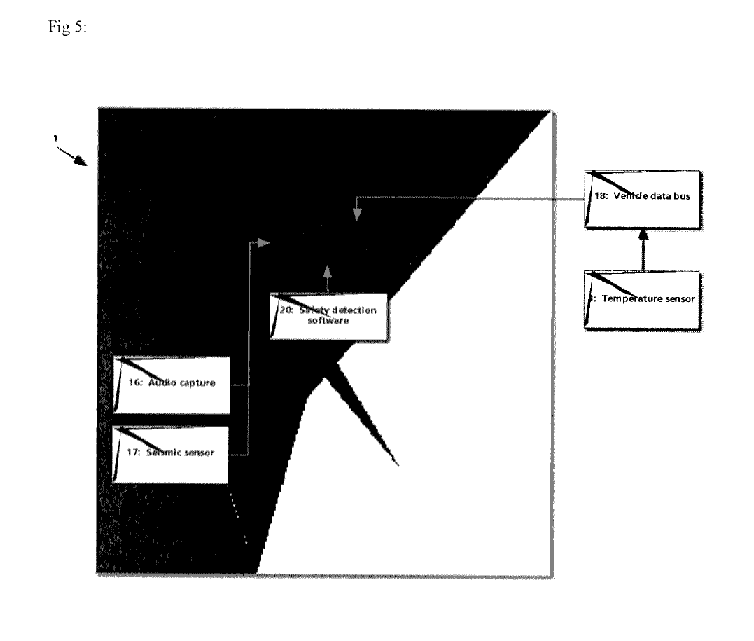

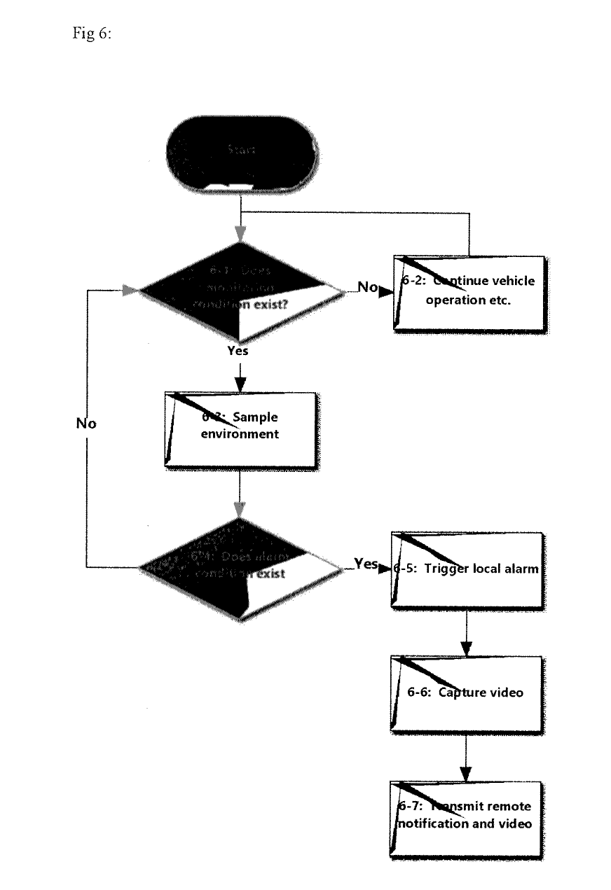

FIGS. 5 and 6 show another embodiment of the system 1 and method of the present invention. Shown in FIG. 5 is a system 1 of the present invention which incorporates a connection to the vehicle data bus 18 of the vehicle in which the system is installed, for demonstrative purposes of the use of sensors or other available information within the vehicle in accordance or in support of the remainder of the method of the present invention.

Referring to the system embodiment shown in FIG. 5 there is shown a system 1 in accordance with the present invention which comprises a controller 2 with safety detection software 20 accessible thereto, a power supply or power system 9 and a plurality of sensors and outputs as outlined in the embodiment of FIG. 3. The carbon dioxide sensor 4 is shown operatively connected to the controller 2, along with a video camera 15, an audio capture device 16, and a seismic sensor 17. The local alarm 6, network interface 7 for the dispatch of remote alarm notifications to remote notification devices, and the geolocation module 8 are also shown.

As discussed in detail elsewhere herein, the controller 2 would in this embodiment be connected to the vehicle data bus 18 which is the data bus within the vehicle via which the controller 2 could read the status of various sensors and controls within the vehicle. Most vehicles now manufactured include an ODBC port through which devices such as the controller 2 of the present invention can be connected to read information from the vehicle data bus 18, and any necessary amendments and modifications to the controller 2 or the safety detection software 20 to allow for connection and interoperability of the control 2 with the vehicle data bus 18 of a particular vehicle will be understood to be within the scope of the present invention.

Shown in this Figure for the sake of demonstration, the temperature sensor 3 in this case at your sensor already integrated with the vehicle, and which is accessible to the controller 2 via the vehicle data bus 18. It will be understood that the temperature sensor already installed the vehicle could comprise the primary temperature sensor used within the method of the present invention, or could also be used in a failover or redundancy capacity.

A video capture device 15 is also shown operatively connected to the controller 2. It is specifically contemplated that in certain embodiments of the system of the present invention a video capture device 15 such as a camera could be used to capture video within the cabin or other isolated space of the vehicle for the purpose of archiving, storage or transmission of that video to ascertain the safety or status of living beings within the vehicle space upon the detection of alarm condition, or in other embodiments as outlined elsewhere herein, the safety detection software 20 could actually be programmed to analyse video captured by the video capture device or camera 15 to further validate the detection or determination of the presence of living beings within the vehicle. It is specifically contemplated that both such enhancements could be provided to the system 1 in the method of the present invention where a video camera or capture device 15 is included i.e. video could be captured, stored and/or transmitted in the case of a controller 2 having a remote network interface 7, so that the recipient of remote alarm notifications could check on the status of the living beings within the vehicle cabin or isolated space, and/or the video captured by the camera 15 could also be used to analyse whether or not there was the presence of living beings within the vehicle for the purpose of the determination of the existence of an alarm condition. One or more video capture devices 15 could be used and any type of a video capture device which could be installed within the cabin or isolated space of the vehicle for the purpose of ascertaining the presence of living beings therein and/or capturing video to verify their state or status are all contemplated within the scope of the present invention.

Also shown in this Figure for demonstrative purposes is an audio capture device 16—a microphone or the like—which could be used to detect sound within the vehicle space or cabin and the sound which is captured could again be stored and transmitted along with a remote alarm notification, or could at the very least be used again to detect the presence of living beings within the vehicle cabin or isolated vehicle space. Finally a seismic sensor 17 is shown, which could be used to detect movement within the cabin the vehicle—as outlined elsewhere. It will be understood that many different types of sensors can be used to ascertain the presence of living beings within an unsafe environment in the vehicle and any type of a sensor which could be connected to the controller 2 and its input integrated into the algorithm or logic applied by the safety detection software 20 for the purpose of determination of the existence of an alarm condition are all contemplated within the scope of the present invention. Also as outlined elsewhere, sensors which are previously installed in the vehicle and the readings from which are accessible via the vehicle data bus 18 could also be used by the controller 2 and the software 20 to determine the presence of living beings therein. For example occupancy sensors and the seats of the vehicle could be used—where they already existed for example in the vehicle—such that the determination of the existence of alarm condition and the vehicle could be made by sensing the presence of bodies on the seats in the vehicle etc. in addition to or in place of the sensing of carbon dioxide and temperature levels in the cabin or isolated space.

FIG. 6 is a flowchart demonstrating the operation of the method of the system 1 shown in FIG. 5. The method demonstrated in the flowchart of FIG. 6 is shown identical to that of FIG. 4 in its first number of stamps. Where an alarm condition is determined to exist, at 6-4, a local alarm would be triggered, at step 6-5 and video would then be captured from the video capture device 15. The video could either just be stored in the memory of the controller 2, or could be transmitted via the network interface 7 of the controller 2 along with the remainder of a remote alarm notification to at least one remote notification device so that the recipient of the remote alarm notification could review the video to ascertain the status or safety of the living beings within the cabin or isolated space in the vehicle.

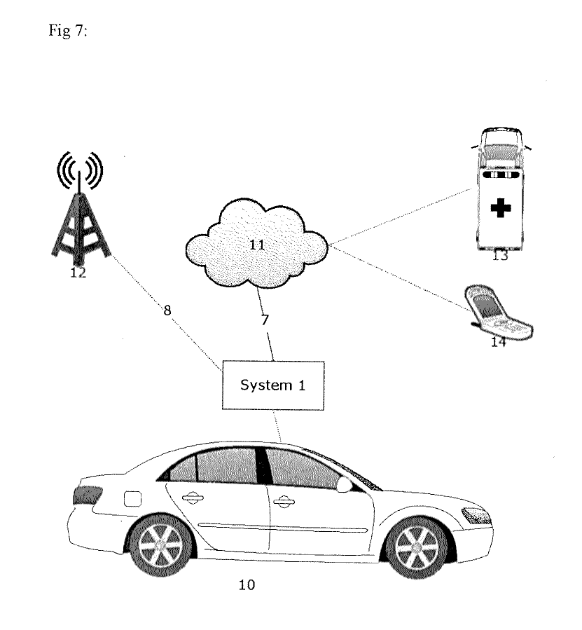

FIG. 7 is a schematic diagram of the overall system of the present invention installed in a vehicle. The system 1 is shown installed in the vehicle 10. The system 1, as outlined elsewhere above, includes the geolocation module 8. One or more geolocation towers, satellites or other external GPS transmitters or inputs are shown at 12—the geolocation module 8 would use this input to ascertain the location of the vehicle 10 and include application within the transmission of remote notification of an alarm condition is determined to exist.

In addition to the geolocation module 8, the network interface 7 is also shown. The network interface 7 could be one or more network interfaces to one or more networks or communication protocols 11, by which remote notifications of the existence of an alarm condition within the cabin of the vehicle 10 could be transmitted. The network interface or interfaces 7 could for example transmit via the cloud or various network protocols 11 an IP-based notification to a communications centre of safety personnel 13, for example or additionally or in place of an IP network or other type of wide-area network protocol, an SMS message could for example be sent to the cell phone of a user, shown at 14.

It will be understood that the basic hardware configuration demonstrated in FIG. 5 is really intended to simply demonstrate the high-level components which would be in for more than a basic embodiment of the system and method of the present invention will be understood that other types of approaches and more complicated hardware embodiments can also be created which would be encompassed within the scope of the present invention.

### Controller:

As outlined above, the system controller 2 would be an electronic module capable of operation based upon software 20 installed thereon to execute the protection method of the present invention. Many different types of microprocessors and similar devices are known to those skilled in the art of electronic component design and all are contemplated within the scope hereof.

One of the key elements of the controller 2 would be the software 20 installed thereon. The software 20 installed on the controller 2 would contain or dictate the parameters for the execution of the remainder of the method of the present invention again, microprocessor programming and the compiling of code capable of controlling such a microprocessor will be understood to those skilled in the art of microprocessor and electronic component design and programming and again any such software is contemplated within the scope of the present invention. A typical microprocessor such as is contemplated for the controller 2 would comprise a CPU, a clock circuit and memory containing both operating instructions and potentially software instructions. The memory on the controller 2 might also contain additional software files or media such as audio files for playback if a local alarm or notification 5 is triggered which comprises an audio file playback or the like.

The software 20 contained on the controller 2 would also include the algorithms or parameters which were used to characterize or detect the existence of an alarm condition. By adjusting the software 20 on the controller 2, the parameters of either such algorithm or other aspects of the method of the present invention is are executed by the controller 2 of the software thereon could be modified without departing from the intended scope hereof as well.

The controller 2 would have an input bus, being a communications bus by which one or more input sensors could communicate with the controller 2. The input bus would be a key physical aspect, along with related software and control instructions, to allow the software 20 and the remainder of the components on the controller 2 to communicate with the temperature sensor 3 and the carbon dioxide sensor 4. Many different types of microprocessors or controllers 1, which included an input bus capable of communicating with sensors of this type, can be contemplated and will be understood by those skilled in the art design of these types of systems and all such types of controllers 1 are contemplated again within scope of the present invention.

Certain embodiments of the controller 2, as outlined with respect to the hardware embodiment shown in FIG. 3 or FIG. 5, might also include a network interface 7 which would allow the controller 2 to transmit remote alarm notifications of the existence of alarm conditions to remote users including the owner of the vehicle of the system, police or safety authorities or the like.

The network interface 7 could be integrated within the remainder of the controller 2, or could be a separate component connected by a communications bus with the controller 2. Both such approaches are contemplated within the scope of the present invention. The network interface 7 itself might for example comprise an IP protocol interface to an IP network which would allow for wide area communications, or might alternatively comprise an SMS connection, cellular modem or the like—IP or SMS communications would be only two of many different types of network communications or protocols which could be used in certain embodiments of the controller 2 of the present invention to allow for communications of various types to be dispatched to remote parties when the safety or alarm condition exists.

Also as outlined elsewhere herein, the controller 2 might contain a geolocation module 8—this would be a GPS unit or otherwise—by which the controller 2 could capture a geolocation of the controller 2 and the related vehicle, so that the related location coordinates could be transmitted along with other details that were to be transmitted to embodiments of the present invention which included the dispatch a remote notification, either to an owner or to safety authorities and the like. Again it is primarily contemplated that the geolocation module 8 would be a GPS receiver, but it could also be one of many of the types of equipment and any type of a receiver or transceiver which would by virtue of some type of communications protocol allowed the controller 2 to capture a meaningful location coordinates in respect of the device are all contemplated within the scope of the present invention.

As outlined elsewhere herein as well, it is explicitly contemplated that one or more embodiments of the controller 2 might be capable of operable connection to the vehicle data bus, also known as the ODB port, on a vehicle to allow for the capture and use of various data readings from the onboard control systems and the vehicle in the operation of the system and method. For example, integrated audio or video capture devices such as the pre-existing microphone for a Bluetooth phone step, pre-existing video cameras in the vehicle, pre-existing or permanently installed temperature sensors, or even occupancy sensors within the seats which were operatively connected to the remainder of the control system of the vehicle, will all provide data channels and data points which could be used by the controller 2 of the software 20 in the execution of the method of the present invention and the operable connection of the controller 2 to the vehicle data bus such that these onboard systems can be used as additional or replacement data channels to the freestanding carbon dioxide and temperature sensors otherwise outlined and disclosed herein are all contemplated within the scope of the present invention.

### Sensors:

There are two types of necessary sensors for the execution of the method of the present invention. These are a temperature sensor 3 and at least one carbon dioxide sensor 4.

The temperature sensor 3 would be any sensor capable of capturing the temperature within the vehicle cabin being monitored by the system 1 and controller 2 of the present invention.

The temperature sensor 3 would communicate with the controller 2 by the input bus thereon. Any type of a temperature sensor 3 capable of interaction with the controller 2 in accordance with the remainder of the present invention, capable of capturing the temperature within the cabin of the vehicle or whatever other isolated and sealed space in the vehicle was being monitored by the system of the present invention, and which could communicate such temperature reading to the controller 2 by the input bus therefore are contemplated to be within the scope of the present invention and any type of temperature sensor 3 capable of participating in the method in this way are being integrated into the hardware and software of this method will be understood to those skilled in the art again of instrumentation and hardware design. It is contemplated that in certain circumstances and embodiments of the system and method, the controller 2 might be connected to the vehicle data bus, such that it could capture readings from pre-existing or onboard sensors on the vehicle which might include an integrated temperature sensor or the like. Use of integrated sensors which are pre-existing in installation on the vehicle, either in addition to or in place of sensors built into the controller or operatively connected to the controller 2 is another approach which is explicitly contemplated within the scope of the present invention.

Similar to the temperature sensor 3, the controller 2 will also be connected to at least one carbon dioxide sensor 4. The carbon dioxide sensor 4, as shown in the hardware embodiment of Two 1 would be located within the primary monitoring or sealed space or cabin of the vehicle and again would be capable of capturing the carbon dioxide readings within the cabin of the vehicle and communicating those by the input bus to the controller 2. Any type of a carbon dioxide sensor 4 capable of operating in this fashion is contemplated to be within the scope of the present invention. They also be the case that the temperature sensor 3 and the carbon dioxide sensor 4 might be manufactured in an integrated fashion i.e. both sensors might be in the same physical hardware unit and might even communicate via a single input bus connection with the controller 2. The temperature sensor 3 and/or the carbon dioxide sensor or sensors 4 could also be integral with the remainder of the controller 2 in the system 1, or could be remotely located sensors, connected by a wired or wireless communications protocol being the input bus, to the controller 2.

Certain embodiments of the system 1 of the present invention, such as that shown in FIG. 3, include more than one carbon dioxide sensor 4. It is contemplated that certain portions of the vehicle, in which humans might not normally be present such as the trunk or the like, may not require a temperature sensor 3 for the purpose of properly determining the presence of an individual therein, but rather in the trunk of the vehicle for example simply the detection of a rising carbon dioxide level and applying the presence of a living individual exhausting carbon dioxide into the cavity would be sufficient to trigger the detection of alarm condition. In that case, and in the case of the hardware shown in FIG. 3, another carbon dioxide sensor 4 could be included and mounted in that particular space, in communication with the controller 2 by the input bus, for the sake of providing secondary monitoring of additional portions of the vehicle in which a safety condition by virtue of the presence of elevated carbon dioxide levels could be detected or rectified based upon proper or early detection.

It is also contemplated that in certain embodiments of the system of the present invention additional types of sensors in addition to the temperature sensor 3 and the carbon dioxide sensor 4 could also be used. For example, a seismic sensor could be used to detect movement within the cabin of the vehicle, seek sensors could be provided which would sense the weight of a seated individual on a seat in the vehicle, or in other embodiments as outlined in further detail below, a video capture device or an audio capture device operatively connected to the controller 2 could be used as another type of a sensor within the cabin of the vehicle to allow for either visual or audible detection of the presence of individuals within the cabin. Any number of different types of sensors will be understood to those skilled in the art of design of these types of equipment, which could be helpful in the determination of the presence of living beings within the cabin or other isolated space of a vehicle when being monitored in accordance with the remainder of the method of the present invention and will be understood that all such types of sensors including those outlined herein and others which might logically be understood to those skilled in the art and are all contemplated within the scope of the present invention.

In the case of an embodiment of the system 1 of the present invention that was connected to the vehicle data bus 18, sensors or other data readings from the vehicle itself could be used in the measurement or determination of the existence of an alarm condition—for example where an audio sample was required from inside the vehicle and there was a microphone integrated in the vehicle which was accessible via the vehicle data bus, audio from the microphone can be sampled in that way rather than needing to incorporate an additional microphone in the controller 2. Readings of the various instruments in the vehicle or even the ignition status of the vehicle could be captured from the vehicle data bus 18 as well, minimizing the need for additional vehicle connections of the system 1

### Local Alarm or Notification:

In basic embodiments of the present invention it is contemplated that the alert which would be provided upon detection of an alarm condition within the cabin of the vehicle would be a local alarm or notification 5, such as a visible or audible signal to those in the vicinity of the motor vehicle to check the safety of individuals therein etc. If the local alarm or notification 5 is an audible alarm, the local alarm or notification 5 could include an external speaker on the vehicle such that an alert tone or siren, or any type of a playable electronic audio file, could be used to explain to those in the vicinity of the vehicle what type of condition might exist and the steps that should be taken. For example an audio file could be played back on an external speaker which explicitly outlined that the vehicle should be checked for the safety of individuals within the vehicle based upon the carbon dioxide levels etc. It will be understood to those skilled in the art of electronic systems design that many types of alarm hardware from the perspective of an audible alarm audible outside of the motor vehicle in which the system 1 of the present invention was installed could be used and all such approaches are contemplated within the scope of the present invention. The local alarm might also or alternatively comprise a connection to the form of the vehicle such that the horn could be set on where an alarm condition was determined to exist within the cabin or isolated space of the vehicle.

Local alarm or notification hardware 5 could comprise a portion of the freestanding system module 1, or an extra speaker for example might be mounted underneath the hood or outside of the vehicle and connected to the remainder of the system module 1. Integrated hardware or separate components will both be understood to be possible approaches to this aspect of the invention as well. It is explicitly contemplated in first instance that the local alarm or notification 5 will comprise a weatherproof speaker mounted outside of the vehicle cabin, although as outlined, there are many other approaches which can be tried and all of which are contemplated within the scope hereof. Any type of a visible or audible alarm 5 which would within the vicinity of the vehicle causing alert for those around the vehicle to check the safety of anyone therein is what is contemplated from this perspective.

In addition to an audible alarm which could be played back or sound locally upon the detection of condition and the remainder of the method of the present invention, visible alarms 5 can also be used. This might consist of flashing lights of the vehicle with an operative system interconnect for the system 1 with the electrical systems of the vehicle, or alternatively a purpose built Beacon or visible signal of some kind could be installed on the vehicle and connected to the remainder of the system module 1 for activation upon the detection of a condition requiring the triggering of a local alarm or notification in accordance with the remainder of the method of the present invention. Again, whether the visible alarm components, if used, comprise a portion of an integrated hardware module 1, or were separately installed on the vehicle and operatively interconnected therewith, both such approaches are contemplated within the scope hereof.

### Network Interface and Remote Notification:

In other embodiments of the system 1 of the present invention, such as that shown in FIGS. 3 and 5, in addition to a local alarm or notification 5, the system 1 could also be configured with a network interface 7 to allow the system 1 to transmit a remote alert or notification to other devices operatively connected to one or more communications networks via set network interface 7, when alarm condition exists. For example, the network interface 7 might operate in conjunction with the remainder of the controller hardware and software to allow for the dispatch of electronic notification of the existence an alarm condition to a device of the owner of the vehicle—for example an SMS text message or the like could be dispatched via the network interface 7. Alternatively the owner of the vehicle, safety authorities can also be summoned by remote notification. An additional aspect of the remote alert a remote notification functionality would be to also incorporate a geolocation module 8 within the remainder of the device—a GPS receiver or the like—whereby upon the detection of alarm condition occasioning of remote notification to be transmitted via the network interface 7, the location of the system 1 and the related vehicle could be captured from the geolocation module 8 and transmitted along with the remainder of the application such that for example if safety authorities and the like would be notified that could be notified not only of the existence of the work condition but also of the location of the vehicle from the perspective of the most streamlined dispatch of safety personnel.

Geolocation interfaces, such as a GPS receiver of the like 8, are well understood to those skilled in the art of mobile electronics design, and any number of different types of modules or interfaces 8 could be incorporated for this purpose. In certain embodiments of the system 1 of the present invention, the hardware of the system 1 might also use a pre-existing GPS network or receiver on the vehicle in the place of a purpose built geolocation module 8, and for example could then capture the GPS location of the vehicle off of the main communications bus in the vehicle for incorporation into a remote notification. Both such approaches are contemplated within scope of the present invention.

### Supplemental Sensors:

More than one carbon dioxide sensor could be placed in locations within the vehicle, to provide monitoring, and safety redundancy, functionality to the system 1 of the present invention. For example, redundancy of more than one carbon dioxide sensor might be provided within the primary cabin of the vehicle, such that if one carbon dioxide sensor responsible for monitoring levels within the cabin of the vehicle was to fail, having a second carbon dioxide sensor operatively connected to the remainder of the control system 1 which could operate in failover mode to provide continued monitoring of the carbon dioxide levels in the vehicle cabin until the primary sensor could be replaced or repaired, is one contemplated modification to the basic system 1 of the present invention which it is contemplated to be within the scope hereof.

In addition to the possibility of providing additional sensors from a redundancy perspective within a primary monitoring space in the vehicle, it will also be understood that in other embodiments of the present invention, auxiliary carbon dioxide sensors might be provided in other sealed locations on the same vehicle, such that effectively more than one sensor could monitor carbon dioxide levels in more than one sealed area of the vehicle, using the same hardware and notification components. For example, in the embodiment shown in FIG. 3, there is shown a second carbon dioxide sensor.

Other sensor types might also be used to add enhanced cabin monitoring to a vehicle in addition to the basic method outlined herein. These might include audio sensors, video detection and image processing equipment, seismic sensors, occupancy sensors are different types already built into the vehicle, or any number of additional types of sensors which are capable of assisting in the determination of the presence of living beings within the confined spaces of vehicle when a alarm condition is to be determined in accordance with the remainder of the system and method of the present invention. As outlined elsewhere herein any such type of sensor is contemplated within the scope of the present invention.

### Other Possible Detection Actions:

The system of the present invention either in place of or in addition to the remote or local alarm or notification a notification functionality might be configured to automatically start the vehicle to reduce the carbon dioxide levels therein, operate the heating or cooling in the vehicle or the like. Any number of other types of controls or actions which could be triggered based upon a control output from the safety alert system 1 of the present invention exist. It will be understood that any such type of modification or enhancement to the basics safety monitor system 1 of the present invention which would allow for additional interactivity with the existing systems of a motor vehicle in which the system 1 was installed, or otherwise, are all contemplated within the scope of the present invention.

### Redundancy:

As outlined elsewhere herein, the system and method of the present invention might include further hardware redundancy to maximize the safety and uptime or availability of the system of the present invention. For example redundant power supplies, redundant sensors, or entire redundant system could be installed in the cabin of a particular motor vehicle in certain cases. Some embodiments of the system of the present invention might include complete component redundancy, and other embodiments of the system of the present invention might only include redundancy on particular electronic components. Both such approaches are contemplated within the scope hereof.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context.

1. A safety alert system for use on a motor vehicle having a vehicle cabin to detect and notify of an alarm condition, said system comprising:
a. a controller for mounting onboard the vehicle, said controller having a processor with safety detection software executable thereon;
b. a carbon dioxide sensor for location within the vehicle cabin and operatively connected to the controller to provide carbon dioxide readings from within the vehicle cabin to the processor;
c. a temperature sensor for location within the vehicle cabin and operatively connected to the controller to provide temperature readings from within the vehicle cabin to the processor;
d. a local alarm or notification device operatively connected to the controller and attached onboard the vehicle to provide notification outside the vehicle when actuated;
wherein the alarm condition to be detected is the unsafe presence of a living being in the vehicle cabin;
wherein the controller, using the safety detection software, will determine the existence of an alarm condition based upon the sensor readings received from the carbon dioxide sensor and the temperature sensor; and
wherein upon detection of the existence of an alarm condition the controller will actuate the local alarm or notification device to provide local alert notification within the vicinity of the vehicle.

2. The system of claim 1 wherein the local alarm or notification device is a visible indicator.

3. The system of claim 1 wherein the local alarm or notification device is a siren or a speaker allowing for the audible playback of stored alert messages within the vicinity of the motor vehicle.

4. The system of claim 1 further comprising a network interface on the controller being connected to a network, and wherein on detection of existence of an alarm condition in the vehicle cabin remote alert notifications can be transmitted to a remote device.

5. The system of claim 4 wherein the remote device is a portable smart device of the vehicle operator, or a communications device of law enforcement or emergency personnel.

6. The system of claim 1 further comprising at least one auxiliary carbon dioxide sensor located within an isolated compartment of the motor vehicle apart from the cabin, operatively connected to the controller, wherein the alarm condition to be detected includes the detection of elevated carbon dioxide levels, signifying human presence, within the isolated compartment within which the auxiliary carbon dioxide sensor is located.

7. The system of claim 1 further comprising a power supply operatively connected thereto.

8. The system of claim 1 wherein the controller is operatively connected to the vehicle data bus such that the controller can use onboard control readings in the vehicle in determining the existence of the alarm condition.

9. The system of claim 8 wherein the temperature sensor is a pre-existing onboard temperature sensor in the vehicle, accessible to the controller via its connection to the vehicle data bus.

10. The system of claim 8 wherein the controller uses the vehicle ignition status in determining the existence of the alarm condition.

11. The system of claim 10 wherein the controller will only monitor for existence of the alarm condition if the vehicle is not operating.

12. The system of claim 1 wherein the detection parameters of the alarm condition used by the controller can be adjusted by a user.

13. The system of claim 1 further comprising a video capture device operatively connected to the controller and located within the vehicle cabin.

14. The system of claim 13 wherein upon detection of the alarm condition the controller will capture and store video from said video capture device.

15. The system of claim 14 wherein the captured video is transmitted to a remote device.

16. The system of claim 15 wherein the remote device is a portable smart device of the vehicle operator, or a communications device of law enforcement or emergency personnel.

17. The system of claim 13 wherein the controller will process video from the video capture device to ascertain the presence of living beings in the vehicle in the detection of the alarm condition.

18. The system of claim 13 wherein the controller will process video from the video capture device to ascertain the presence of living beings in the vehicle on deactivation of the ignition of the vehicle, and provide a local notification to the operator of the vehicle if living beings are left in the vehicle.

19. The system of claim 1 further comprising an audio capture device operatively connected to the controller and located within the vehicle cabin.

20. The system of claim 13 wherein the controller will process audio from the audio capture device to ascertain the presence of living beings in the vehicle in the detection of the alarm condition.

21. The system of claim 1 further comprising a seismic sensor operatively connected to the controller to capture readings related to living beings present in the cabin of the vehicle, the readings from which could be used in in the determination of the existence of the alarm condition.

22. A method of detection of an alarm condition in the environment of the vehicle cabin of a motor vehicle, said alarm condition being the unsafe presence of at least one living being in the vehicle cabin, said method comprising:
a. providing a safety alert system within the motor vehicle comprising:
i. a controller for mounting onboard the vehicle, said controller having a processor with safety detection software executable thereon;
ii. a carbon dioxide sensor for location within the vehicle cabin and operatively connected to the controller to provide carbon dioxide readings from within the vehicle cabin to the processor;
iii. a temperature sensor for location within the vehicle cabin and operatively connected to the controller to provide temperature readings from within the vehicle cabin to the processor; and
iv. a local alarm or notification device operatively connected to the controller and attached onboard the vehicle to provide local notification in the vicinity of the vehicle when actuated;
b. using the safety alert system:
i. periodically capturing temperature and carbon dioxide readings within the cabin of the vehicle from the temperature sensor and the carbon dioxide sensor to the controller;
ii. using the controller and safety detection software, determining the existence of an alarm condition based on the captured temperature and carbon dioxide readings;
iii. where an alarm condition is detected by the controller, actuating the local alarm or notification device to provide a local alarm or notification notification in the vicinity of the vehicle.

23. The method of claim 22 wherein the system further comprises at least one auxiliary carbon dioxide sensor located within an isolated compartment of the motor vehicle apart from the cabin, operatively connected to the controller; and wherein the alarm condition to be detected includes the detection of elevated carbon dioxide levels, signifying human presence, within the isolated compartment within which the auxiliary carbon dioxide sensor is located.

24. The method of claim 22 wherein the controller is operatively connected to the vehicle data bus such that the controller can use onboard control readings in the vehicle in determining the existence of the alarm condition.

25. The method of claim 24 wherein the temperature sensor is a pre-existing onboard temperature sensor in the vehicle, accessible to the controller via its connection to the vehicle data bus.

26. The method of claim 24 wherein the controller uses the vehicle ignition status in determining the existence of the alarm condition.

27. The method of claim 22 wherein the system further comprises a network interface on the controller being connected to a network via which the controller can communicate with at least one remote notification device, and wherein on detection of existence of an alarm condition in the vehicle cabin remote a remote alert notification is transmitted to said at least remote notification device.

28. The method of claim 27 wherein the remote notification device is a portable smart device of the vehicle operator, or a communications device of law enforcement or emergency personnel.

29. The method of claim 27 wherein the system further comprises a video capture device operatively connected to the controller and located within the vehicle cabin.

30. The method of claim 29 wherein the controller will process video from the video capture device to ascertain the presence of living beings in the vehicle in the detection of the alarm condition.

31. The method of claim 29 wherein the controller will process video from the video capture device to ascertain the presence of living beings in the vehicle on deactivation of the ignition of the vehicle, and provide a local notification to the operator of the vehicle if living beings are left in the vehicle.

32. The method of claim 29 wherein upon detection of the alarm condition the controller will capture and store video from said video capture device.

33. The method of claim 33 wherein the captured video is transmitted to the remote notification device with the remote alert notification.

34. The method of claim 22 wherein the system further comprises an audio capture device operatively connected to the controller and located within the vehicle cabin.

35. The method of claim 34 wherein the controller will process audio from the audio capture device to ascertain the presence of living beings in the vehicle in the detection of the alarm condition.

36. The method of claim 22 wherein the system further comprises a seismic sensor operatively connected to the controller and located within the vehicle cabin, and the controller uses the readings from said seismic sensor along with other available information to determine the existence of an alarm condition.

37. The method of claim 22 wherein the controller would only monitor the environment within the vehicle cabin when the vehicle ignition was turned off.
